(19) United States
(12) Patent Application Publication
(10) Pub. No.: US 2006/0172831 A1
(43) Pub. Date: Aug. 3, 2006

(54) Holding device for a rear derailleur of a bicycle

(76) Inventor: Yi-Ling Wen, Fengyuan City (TW)

Correspondence Address: DELLETT & WALTERS, P. O. BOX 82788, PORTLAND, OR, 97282-0788, US

(21) Appl. No.: 11/047,974

(22) Filed: Jan. 31, 2005

(51) Int. Cl. F16H 59/00; F16H 61/00; F16H 63/00

(52) U.S. Cl. 474/82; 474/80

(57) ABSTRACT

A holding device has a holding base, a connecting element and a holding bolt. The connecting element is attached to the holding base and has a threaded hole defined through the connecting element. The holding bolt is screwed onto the holding base to hold the rear derailleur. Accordingly, the rear derailleur is kept from shaking with the holding device during the travel of the bicycle.

### BACKGROUND OF THE INVENTION

1. Field of the Invention

The present invention relates to a holding device, and more particularly to a holding device for a rear derailleur of a bicycle to securely hold the rear derailleur and to keep the rear derailleur from shaking.

2. Description of Related Art

With reference to reference to FIG. 6, a rear derailleur (62) is connected to a rear fork (60) of a bicycle with a connecting plate (600), and the connecting plate (600) is securely attached to the rear fork (60) with a fastener (601). However, because the rear derailleur (62) is connected to the rear fork (60) at a single fastener (601), the rear derailleur (62) easily shakes relative to the rear fork (60) during the travel of the bicycle so that the operation of the rear derailleur (62) is not precise. In addition, the connecting plate (600) is easily bent or deformed when the rear derailleur (62) bumps with another object, and the operation of the rear derailleur (62) easily fails.

With reference to FIG. 7, a protective frame (70) is attached to the connecting plate (600) to keep the rear derailleur (62) from bumping with another object, such that the deformation of the connecting plate (600) is prevented. However, the rear derailleur (62) still easily shakes during the travel of the bicycle even when the protective frame (70) is provided.

To overcome the shortcomings, the present invention tends to provide a holding device for a rear derailleur to mitigate or obviate the aforementioned problems.

### SUMMARY OF THE INVENTION

The main objective of the invention is to provide a holding device for a rear derailleur of a bicycle and that can keep the rear derailleur from shaking. The holding device has a holding base, a connecting element and a holding bolt. The connecting element is attached to the holding base and has a threaded hole defined through the connecting element. The holding bolt is screwed onto the holding base and is adapted to hold the rear derailleur.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a holding device in accordance with the present invention;

FIG. 2 is a perspective view of a rear fork and a rear derailleur of a bicycle with the holding device in FIG. 1;

FIG. 3 is a side plan view in partial cross section of the rear fork, the rear derailleur and the holding device in FIG. 2;

FIG. 4 is an operational side plan view in partial cross section of the holding device in FIG. 1 applied to another type of bicycle;

FIG. 5 is an exploded perspective view of another embodiment of a holding device in accordance with the present invention;

FIG. 6 is a perspective view of a conventional way of attaching a rear derailleur to a rear fork of a bicycle in accordance with the prior art; and

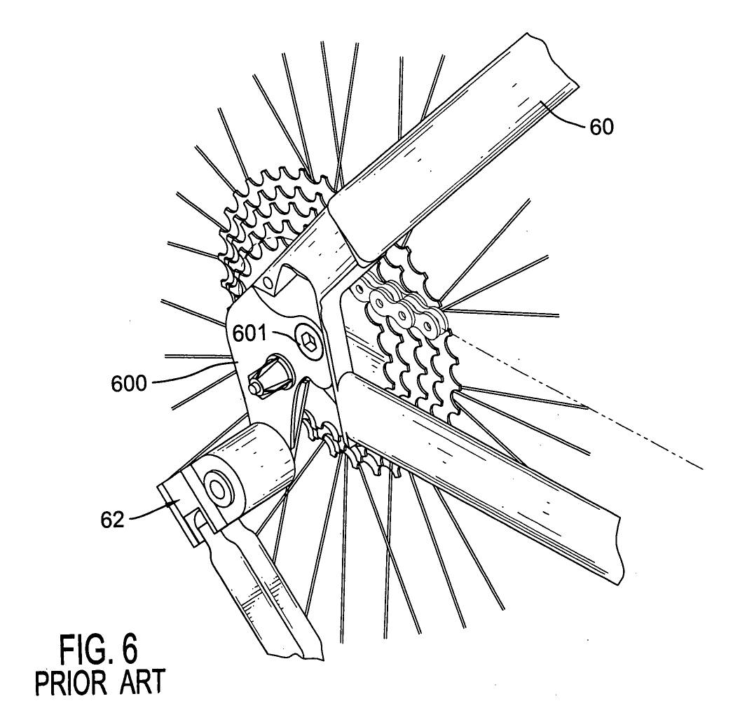

FIG. 7 is a side plan view in partial cross section of another embodiment of attaching a rear derailleur to a rear fork of a bicycle in accordance with the prior art.

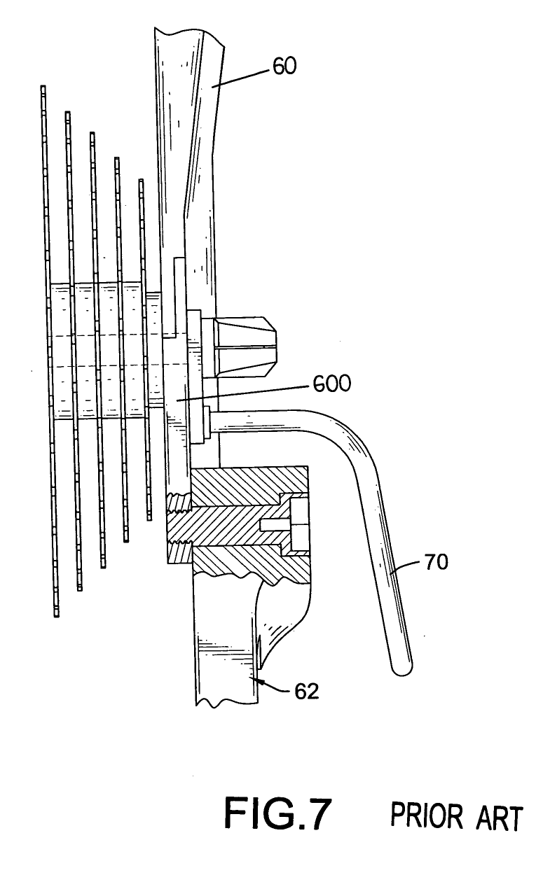

### DETAILED DESCRIPTION OF PREFERRED EMBODIMENT

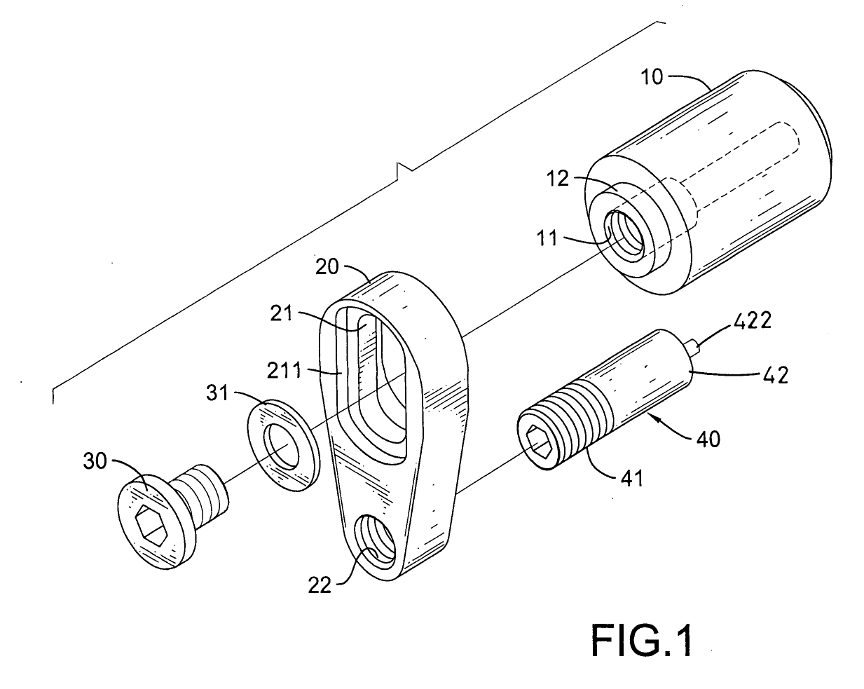

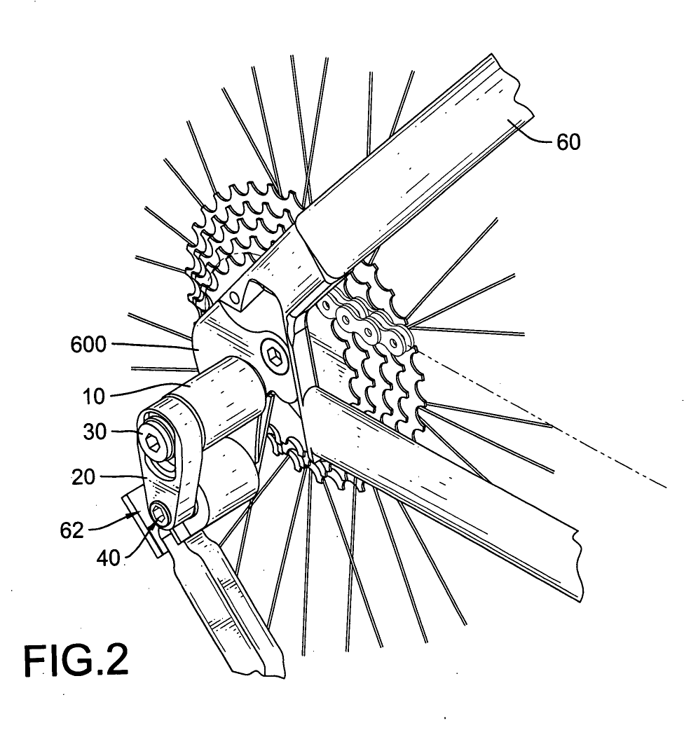

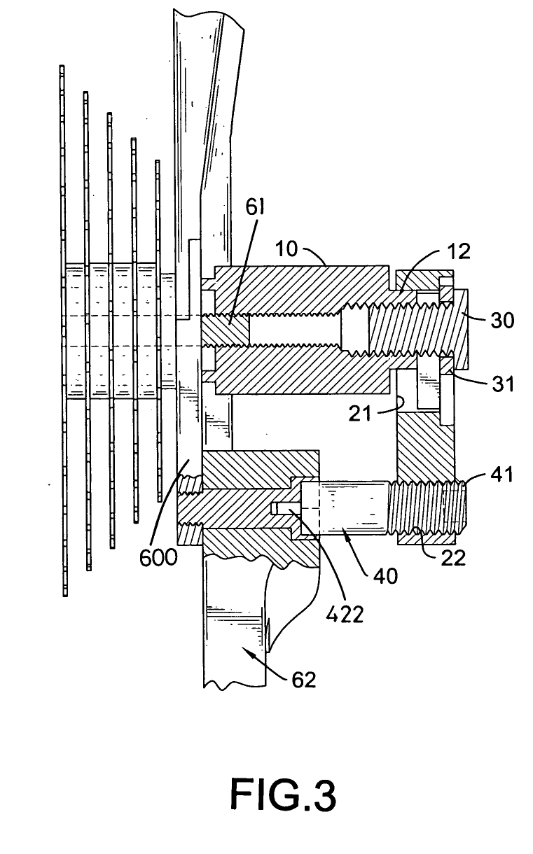

With reference to FIGS. 1 to 3, a holding device for a rear derailleur (62) of a bicycle in accordance with the present invention comprises a holding base (20), a connecting element (10) and a holding bolt (40). The holding base (20) has a longitudinal slot (21) and a threaded hole (22) defined respectively through the holding base (20).

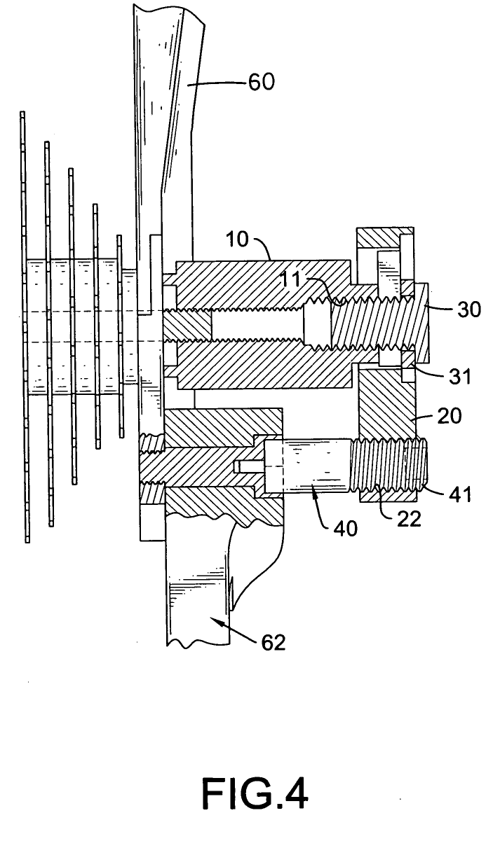

The connecting element (10) and the holding bolt (40) are mounted on one side of the holding base (20). The connecting element (10) is attached to the holding base (20) and has a threaded hole (11) defined through the connecting element (10). The threaded hole (11) in the connecting element (10) is screwed with a wheel axle (61) of the bicycle to connect with the bicycle. The connecting element (10) further has a protrusion (12) formed on one end of the connecting element (10) and extending into the longitudinal slot (21) in the holding base (20). The holding base (20) further has an enlarged recess (211) defined in the holding base (20) at a side opposite to the connecting element (10) and communicating with the longitudinal slot (21). A washer (31) is mounted inside the enlarged recess (211). A bolt (30) extends through the washer (31) and the longitudinal slot (21) and is screwed into the threaded hole (11) in the connecting element (10) so as to securely hold the holding base (20) with the connecting element (10). When the bolt (30) is released, the holding base (20) can move relative to the connecting element (10) along the longitudinal slot (21) to adjust the position between the holding base (20) and the connecting element (10), such that the holding device can be applied to different bicycle as shown in FIG. 4.

One end of the connecting element (10) abuts against a connecting plate (600) on which the rear derailleur (62) is mounted to securely hold the connecting element (10) with the holding base (20) on the rear fork (60).

The holding bolt (40) is screwed onto the holding base (20) and is adapted to hold the rear derailleur (62). The holding bolt (40) has a threaded end (41) screwed into the threaded hole (22) in the holding base (20) and a holding end (42) abutting with the rear derailleur (62). A stub (422) protrudes from the holding end (42) of the holding bolt (40) to extend into the rear derailleur (62).

With the holding device, the rear derailleur (62) can be securely held and is keep from shaking during the travel of the bicycle, such that the operation of the rear derailleur (62) is precise. In addition, with the arrangement of the holding device, the rear derailleur (62) can be prevented from bumping with another object, such that the deformation of the connecting plate (600) and damage of the rear derailleur (62) are avoided.

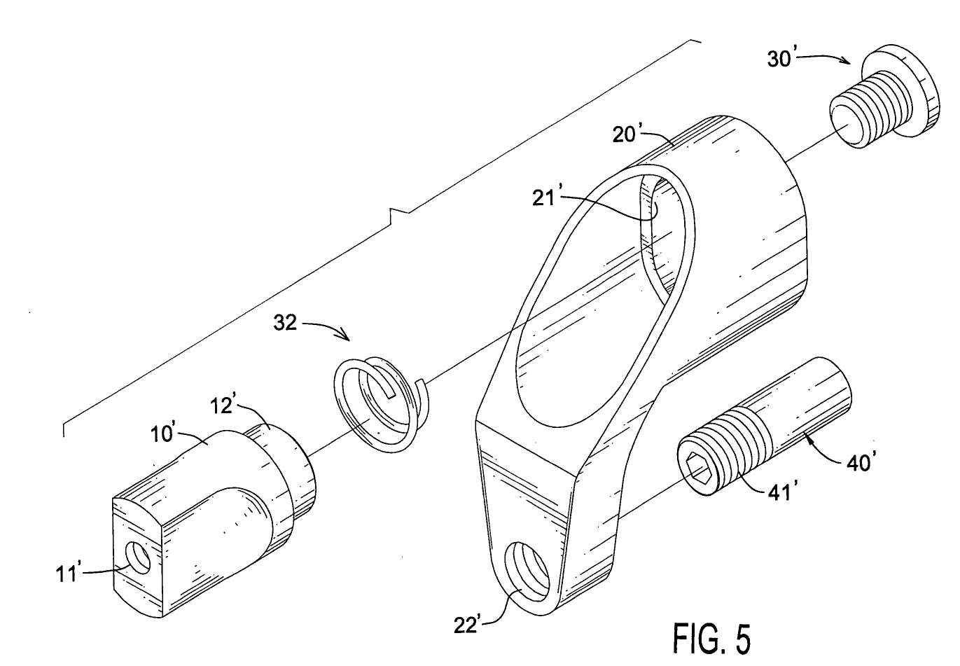

With reference to FIG. 5, the connecting element (10′) and the holding bolt (40′) are mounted respectively on two sides of the holding base (20′). The holding base (20′) has a longitudinal slot (21′) defined through the holding base (20′), and the connecting element (10′) has a protrusion (12′) extending into the slot (21′) in the holding base (20′).

The connecting element (10′) has a threaded hole (11′) defined through the connecting element (10′). A resilient member (32) is mounted between the holding base (20′) and the connecting element (10′). A bolt (30′) extends through the slot (21′) in the holding base (20′) and is screwed into the threaded hole (11′) in the connecting element (10′) to securely hold the connecting element (10′) on the holding base (20′) with the resilient force provided by the resilient member (32). The holding base (20′) has a threaded hole (22′). The holding bolt (40′) has a threaded end (41′) screwed into the threaded hole (22′) in the holding base (20′). Accordingly, another embodiment of a holding device in accordance with the present invention is provided.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A holding device for a rear derailleur of a bicycle comprising:
a holding base;
a connecting element adapted to be connected to a rear fork of the bicycle, attached to the holding base and having a threaded hole defined through the connecting element; and
a holding bolt screwed onto the holding base and adapted to hold the rear derailleur.

2. The holding device as claimed in claim 1, wherein the holding base has a longitudinal slot defined through the holding base; and
the connecting element is attached to the longitudinal slot in the holding base.

3. The holding device as claimed in claim 2, wherein the connecting element and the holding bolt are mounted on one side of the holding base; and
the connecting element has a protrusion formed on one end of the connecting element and extending into the longitudinal slot in the holding base.

4. The holding device as claimed in claim 3, wherein the holding base further has an enlarged recess defined in the holding base at a side opposite to the connecting element and communicating with the longitudinal slot;
a washer is mounted inside the enlarged recess; and
a bolt extends through the washer and the longitudinal slot and is screwed into the threaded hole in the connecting element.

5. The holding device as claimed in claim 4, wherein the holding base has a threaded hole; and
the holding bolt has a threaded end screwed into the threaded hole in the holding base.

6. The holding device as claimed in claim 5, wherein the holding bolt further has a holding end adapted to abut with the rear derailleur and a stub protruding from the holding end to extend into the rear derailleur.

7. The holding device as claimed in claim 3, wherein the holding base has a threaded hole; and
the holding bolt has a threaded end screwed into the threaded hole in the holding base.

8. The holding device as claimed in claim 7, wherein the holding bolt further has a holding end adapted to abut with the rear derailleur and a stub protruding from the holding end to extend into the rear derailleur.

9. The holding device as claimed in claim 2, wherein the holding base has a threaded hole; and
the holding bolt has a threaded end screwed into the threaded hole in the holding base.

10. The holding device as claimed in claim 9, wherein the holding bolt further has a holding end adapted to abut with the rear derailleur and a stub protruding from the holding end to extend into the rear derailleur.

11. The holding device as claimed in claim 1, wherein the holding base has a threaded hole; and
the holding bolt has a threaded end screwed into the threaded hole in the holding base.

12. The holding device as claimed in claim 1, wherein the holding bolt further has a holding end adapted to abut with the rear derailleur and a stub protruding from the holding end to extend into the rear derailleur.

13. The holding device as claimed in claim 1, wherein the holding bolt has a holding end adapted to abut with the rear derailleur and a stub protruding from the holding end to extend into the rear derailleur.

14. The holding device as claimed in claim 1, wherein the holding base has a longitudinal slot defined through the holding base; and
the connecting element is attached to the longitudinal slot in the holding base.

15. The holding device as claimed in claim 1, wherein the connecting element and the holding bolt are mounted respectively on two sides of the holding base.

16. The holding device as claimed in claim 15, wherein the holding base has a longitudinal slot defined through the holding base; and
the connecting element is attached to the longitudinal slot in the holding base.

17. The holding device as claimed in claim 16, wherein the holding base has a threaded hole; and
the holding bolt has a threaded end screwed into the threaded hole in the holding base.

18. The holding device as claimed in claim 17 further comprising a resilient member mounted between the holding base and the connecting element; and
a bolt extending through the holding base and screwed into the threaded hole in the connecting element to securely hold the connecting element on the holding base.

19. The holding device as claimed in claim 15 further comprising a resilient member mounted between the holding base and the connecting element; and
a bolt extending through the holding base and screwed into the threaded hole in the connecting element to securely hold the connecting element on the holding base.
